(19) United States
(12) Patent Application Publication
(10) Pub. No.: US 2026/0057261 A1
(43) Pub. Date: Feb. 26, 2026

(54) METHOD AND APPARATUS ENHANCING LLM COMPLEX PROBLEM-SOLVING WITH HYBRID THINKING AND DYNAMIC WORKFLOWS

(71) Applicant: Tencent America LLC, Palo Alto, CA (US)

(72) Inventors: Wenlin YAO, College Station, TX (US); Haitao MI, Palo Alto, CA (US); Dong YU, Palo Alto, CA (US)

(73) Assignee: Tencent America LLC, Palo Alto, CA (US)

(21) Appl. No.: 19/200,837

(22) Filed: May 7, 2025

Related U.S. Application Data
(60) Provisional application No. 63/685,815, filed on Aug. 22, 2024.

(51) Int. Cl. G06N 5/04

(52) U.S. Cl. CPC G06N 5/04

(57) ABSTRACT

A method performed by at least one processor, the method includes receiving a task query; inputting the task query, at a first stage of an automated hybrid task solving model, into one or more large language models (LLMs) to generate a first solution; determining, at the first stage of the automated hybrid task solving model, determining whether the first solution passes a first stage verification; and based on determining the first solution does not pass the first stage verification, iteratively applying a second stage of the automated hybrid task solving model to the task query until a final answer is verified.

### CROSS-REFERENCE TO RELATED APPLICATION

This application claims priority from U.S. Provisional Application No. 63/685,815 filed on Aug. 22, 2024, the disclosure of which is incorporated herein by reference in its entirety.

### FIELD

The disclosure generally relates to enhancing LLM complex problem solving with hybrid thinking and dynamic workflows.

### BACKGROUND

Large language models (LLMs) have made remarkable progress in natural language understanding and generation tasks in recent years. However, their performance on complex reasoning problems that require multiple steps of logical inference and tool usage is still limited compared to human experts. Prior works have explored augmenting LLMs with dedicated reasoning modules and symbolic systems for specific domains like mathematics and programming, but a general approach for arbitrary complex reasoning tasks remains an open challenge.

### SUMMARY

According to an aspect of the disclosure, a method includes receiving a task query; inputting the task query, at a first stage of an automated hybrid task solving model, into one or more large language models (LLMs) to generate a first solution; determining, at the first stage of the automated hybrid task solving model, determining whether the first solution passes a first stage verification; and based on determining the first solution does not pass the first stage verification, iteratively applying a second stage of the automated hybrid task solving model to the task query until a final answer is verified.

According to an aspect of the disclosure, an apparatus includes at least one memory configured to store computer program code; and at least one processor configured to access said at least one memory and operate as instructed by said computer program code, said computer program code including: receiving code configured to cause the at least one processor to receive a task query; inputting code configured to cause the at least one processor to input the task query, at a first stage of an automated hybrid task solving model, into one or more large language models (LLMs) to generate a first solution; determining code configured to cause the at least one processor to, at the first stage of the automated hybrid task solving model, determine whether the first solution passes a first stage verification; and applying code configured to cause the at least one processor to, based on determining the first solution does not pass the first stage verification, iteratively apply a second stage of the automated hybrid task solving model to the task query until a final answer is verified.

According to an aspect of the disclosure, a non-transitory computer readable medium having instructions stored therein, which when executed by a processor cause the processor to execute a method including receiving a task query; inputting the task query, at a first stage of an automated hybrid task solving model, into one or more large language models (LLMs) to generate a first solution; determining, at the first stage of the automated hybrid task solving model, determining whether the first solution passes a first stage verification; and based on determining the first solution does not pass the first stage verification, iteratively applying a second stage of the automated hybrid task solving model to the task query until a final answer is verified.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of an example hybrid thinking model, according to embodiments.

FIG. 4 is an illustration of an example three-stage framework of a dynamic workflow, according to embodiments.

FIG. 5 is an illustration of example data synthesis of complex reasoning problems model, according to embodiments.

FIG. 6 is a flowchart of an example process of selecting and expanding a tree node, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more. ” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a novel hybrid thinking framework that combines fast intuitive reasoning and slow deliberate analysis to tackle general complex reasoning problems across various domains. For easier problems, LLMs can rely on fast thinking (e.g., generating a direct chain-of-thought (CoT)) reasoning process to solve the problem. For harder problems, where fast thinking fails, LLMs need to switch to slow thinking, which dynamically decomposes the problem into subtasks, designs expert reasoning modules, and generates a graph-structured workflow to solve the subtasks in an organized way. An LLM can be trained to adaptively choose between fast and slow thinking based on problem difficulty, leading to a significant performance gain while maintaining efficiency.

Experiments are conducted on four diverse benchmark reasoning datasets: Big-Bench Hard (BBH), MATH, Crosswords and a novel Game of 24 task. The results demonstrate that slow thinking with dynamic workflow significantly outperforms fast thinking on all four reasoning tasks (e.g., boosting the accuracy from 12% to 48% on Game of 24). Hybrid thinking, which adaptively combines fast and slow reasoning, can further improve the performance to 76% on Game of 24 and achieve an average 19% gain over fast thinking on the four datasets. Hybrid thinking also improves the efficiency of reasoning by using slow thinking on fewer cases. The fast/slow thinking ratio is correlated with problem difficulty.

To further scale up the training of the hybrid thinking model, the embodiments includes a novel approach to automatically synthesize a large-scale reasoning dataset from a small number of seed tasks. The synthesized data helps an open-source LLama model to achieve over 10% gains on unseen reasoning tasks after fine tuning.

Accordingly, the embodiments include hybrid thinking, a general framework that combines fast and slow reasoning to improve LLM performance on complex multistep reasoning problems. The embodiments include a novel dynamic workflow approach for slow thinking to decompose hard problems, generate reasoning steps, and improve over chain-of-thought prompting. Conducted experiments demonstrate the effectiveness and efficiency of hybrid thinking on four diverse reasoning benchmarks. The embodiments include a new method to synthesize large-scale reasoning data and show that it enables open-source models to achieve significant gains after fine-tuning.

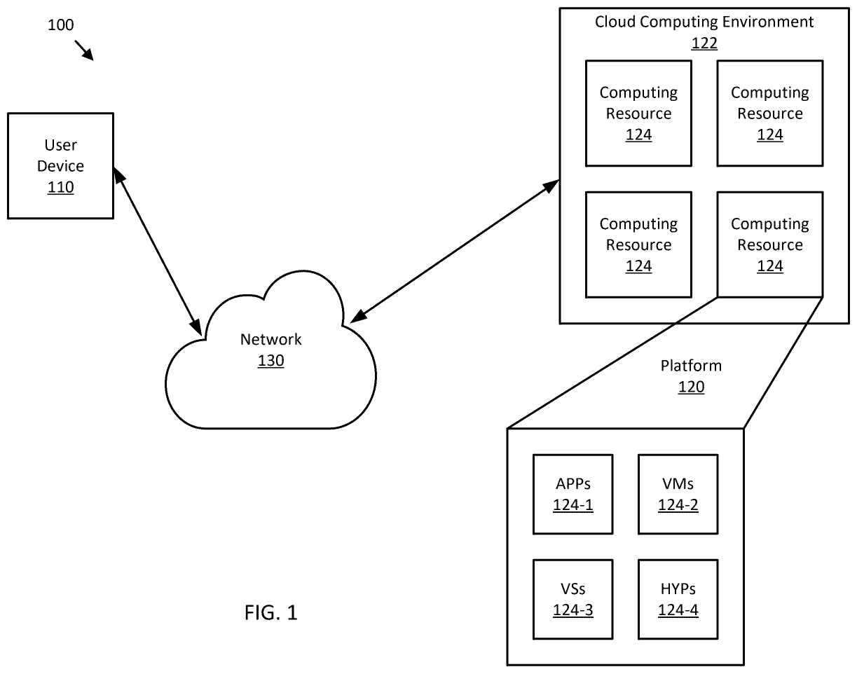

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

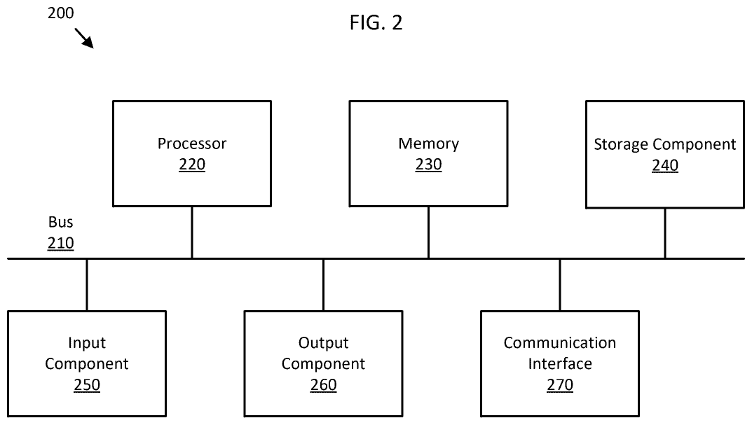

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

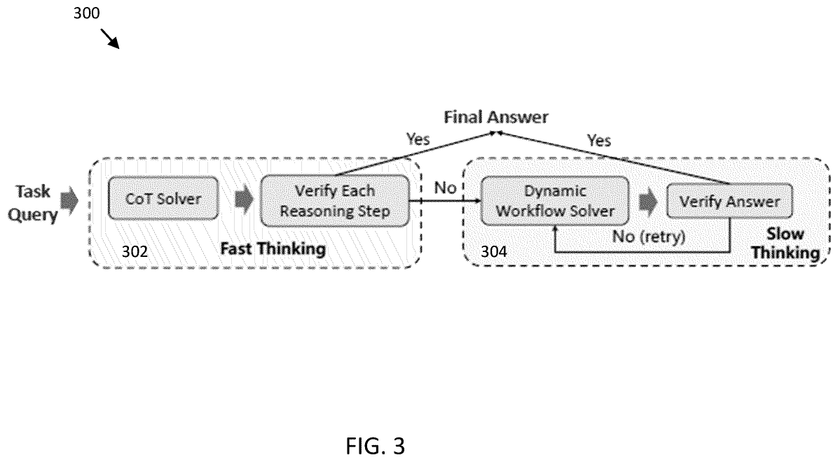

FIG. 3 illustrates an example automated hybrid thinking model 300, according to one or more embodiments. The automated hybrid thinking model 300 may be implemented by the processor 220. The automated hybrid thinking model 300 may be a dual-path approach to problem-solving, beginning, in the fast thinking operation 302, with a CoT solver for initial fast reasoning followed by verification of each reasoning step. If verification fails, the process transitions to a slower, more deliberate “Dynamic Workflow Solver” in a slow thinking operation 304. This solver may iterate until a verified answer is obtained, incorporating a final verification step before concluding with a solution.

The hybrid thinking approach combines the strengths of fast and slow thinking modes to enable LLMs to more effectively solve complex reasoning problems. It consists of the following three key components (1) Fast Thinking with Direct CoT, (2) Adaptive Combination of Fast and Slow Thinking, (3) Slow Thinking with Dynamic Workflow. In the fast thinking mode, the LLM uses a direct chain of thought (CoT) approach to quickly solve the task query if possible. This leverages the LLM's core abilities to perform certain types of reasoning efficiently by directly generating the rationale and the final answer. In Adaptive Combination of Fast and Slow Thinking, if the fast-thinking CoT is unable to confidently answer the query, the system switches to slow thinking with a dynamic workflow that adaptively applies slow thinking to solve it. For example, a self-verification mechanism is employed where the LLM examines each step of the fast-thinking chain-of-thought (CoT) reasoning to assess its confidence in the generated answer. This is achieved by applying the LLM to analyze the coherence, logical consistency, and correctness of each reasoning step in the context of the given query. If the LLM detects any inconsistencies, errors, or low-confidence steps during this self-verification process, it triggers a switch to the slow-thinking mode. In slow thinking with dynamic workflow, given a complex task, multi-level problem reflection and decomposition is first performed. Second, workflow is designed with specialized LLM skills or symbolic tools for each sub-task. Next, the sub-task reasoning steps are dynamically chained together into a multi-step slow-thinking workflow and execute the workflow. Finally, all sub-task results are aggregated into the final answer to the original complex task.

By first attempting fast thinking, the system can efficiently handle queries that are within the LLM's core capabilities. When the query exceeds what fast thinking alone can confidently handle, smoothly transitioning to a slow thinking workflow enables the LLM to still make progress by decomposing the problem. The adaptive combination of fast and slow thinking modes, along with verification of the reasoning steps, allows this hybrid approach to expand the scope of problems LLMs can robustly solve.

In contrast to the rapid, intuitive responses of fast thinking, a new slow-thinking mechanism that applies dynamic workflow to enable a more deliberate, analytical approach to complex problem-solving. The embodiments allow an LLM to dynamically transition between reasoning in the text space (natural language reasoning) and the symbolic space (symbolic reasoning). When possible, the LLM Engine will translate the sub-problem from the text space into the symbolic space, enabling the symbolic engine to perform precise symbolic reasoning. The results are then mapped back into natural language using the LLM Engine. By decomposing the problem, combining the strengths of both natural language and symbolic reasoning in a tailored workflow, and executing it from start to finish, LLMs can tackle very hard problems that require multiple steps of accurate reasoning.

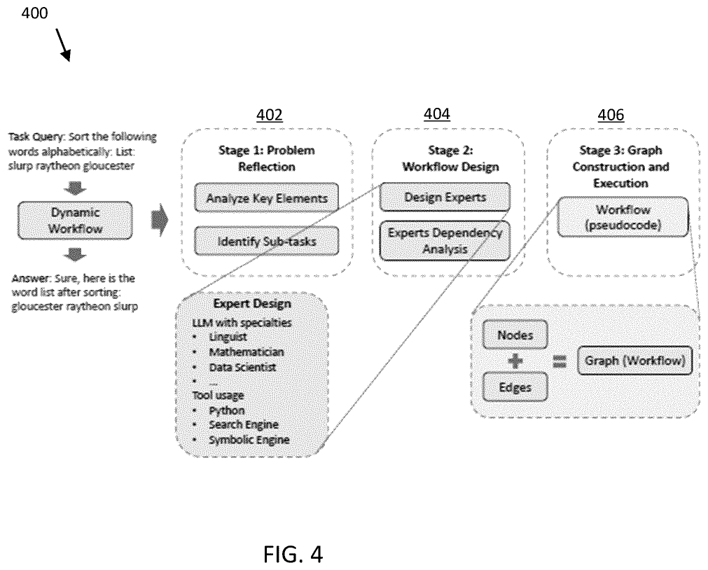

FIG. 4 illustrates an example three-stage framework of a dynamic workflow 400, according to one or more embodiments. The dynamic workflow begins with Problem Reflection in Stage 1 (402), where key elements are analyzed and sub-tasks identified. Stage 2 (404) focuses on Expert Design, utilizing a variety of specialists and tools to architect an optimal workflow. The Stage 3 (406) involves constructing and executing the workflow graph to get the final results.

The first step in slow thinking is to break down the high-level problem statement into more manageable sub-tasks. The LLM is asked to analyze the key elements of the query, such as available information, constraints, and the desired output. The workflow then identifies logical sub-goals needed to progress from the initial state to the solution. This decomposition allows the LLM to approach the problem in a structured manner, focusing on one part at a time. By making the implicit steps explicit, the LLM can catch gaps in reasoning and handle complex queries that the fast thinking of CoT alone would struggle with.

In Stage 1 (402) problem reflection, the first step in tackling complex problems is conducting a thorough problem reflection. This involves the LLM analyzing the original problem and restating it in its own words to demonstrate understanding. In one or more example, the problem reflection may include the following key aspects: 1) Identifying the core objective or question posed by the problem; 2) Recognizing any constraints, assumptions, or special conditions mentioned. By internalizing the problem through reflection, the LLM gains a solid grasp of what needs to be accomplished before proceeding to decomposition.

In multi-level decomposition, once the problem is well understood, the LLM is asked to perform a multi-level decomposition to break it down into some tractable sub-problems. This decomposition may be performed in accordance with the following guidelines: (1) Subsequence dependency, (2) Non-overlapping, and (3) Proper Decomposition, (4) Modular. In sequential dependency, the sub-problems are organized in a logical sequence, such that the outputs of earlier steps feed into subsequent ones, creating a structured workflow from start to finish. In non-overlapping, each sub-problem represents a distinct portion of the original problem, with no duplication of work between sub-problems. This keeps the overall solution efficient. In proper decomposition, the sub-problems are decomposed to the optimal level of granularity-not so small that there are too many to track and coordinate, but not so large that they are still struggling to solve. In Modular, where appropriate, sub-problems are defined in a generalizable, modular way, such that the logic and code used to solve them can potentially be reused to solve similar problems in other contexts.

In Integrating Symbolic Reasoning, another key aspect of our approach is leveraging the symbolic engines to modularize the solution and handle well-defined sub-tasks more accurately. For example, some sub-tasks in the decomposition can often be addressed by writing compact, targeted code functions. This allows the LLM to handle common operations such as mathematical calculations, data parsing and manipulation, and so on without bringing errors. It also provides a mechanism to serialize intermediate results between steps in a structured way. These modular code functions can be invoked as needed in the overall problem-solving flow, with their inputs and outputs flowing seamlessly with the natural language reasoning components.

With the problem decomposed into sub-tasks, the embodiments next include a team of specialized experts in Stage 2 (404), each contributing unique skills and tools, arranged in a dynamic workflow. In one or more examples, the central component is a Meta-Expert, initialized from the foundation LLM, designs the expert team, and coordinates their efforts. The orchestration process has four key steps: 1) Expert Team Design, 2) Workflow Arrangement, 3) Collaboration and Iteration, 4) Final Review and Generation.

In Expert Team Design, based on the identified sub-tasks, the Meta-Expert designs a team of specialized experts. Each expert is assigned a unique name and a clear description of their specific skills, knowledge, and responsibilities. There are two types of experts. The first is the LLM expert, which is a specialized language model that handles tasks related to language understanding, generation, analysis, and verbal reasoning. Examples include Essayist, Linguistic Analyst, Mathematician, Data Scientist, etc. The second is tool experts that utilize external symbolic tools and libraries to perform specific functions. A key example is the Python Expert, which solves a well-defined sub-task by writing code, executing it, and returning the results.

In Workflow Arrangement, the Meta-Expert may arrange the experts into an efficient workflow sequence. Each expert's output serves as the input for the next, progressively moving towards the final solution. The Meta-Expert ensures there is no redundancy of functions across experts.

In Collaboration and Iteration, as the experts work through the problem, the Meta-Expert facilitates collaboration and puts together their inputs and outputs. For sub-tasks involving logical reasoning, mathematical operations, data structures, or programming, the Meta-Expert provides strategic guidance and sends the implementation details to the corresponding Tool Experts.

In Final Review and Generation, the last expert in the workflow, often an LLM specialist, is tasked with holistically reviewing the findings of the previous experts and generating the final solution to the problem.

By combining the power of specialized LLMs and the usage of tools into a customized designed adaptable workflow, the embodiments can tackle complex problems that are beyond the capabilities of a single model or tool. The Meta-Expert serves as the intelligent connector, analyzing the unique needs of each problem and dynamically assembling the optimal workflow.

In Stage 3 (406), with the workflow graph generated, the embodiments may proceed to execute the graph to get the final result. The execution may follow the dependency order, ensuring the correct flow of data between experts. As the workflow progresses, the downstream experts continually update their memory with the intermediate results and insights generated by previous experts. Upon completion of the workflow execution, the last LLM expert analyzes the results, identifies key findings, and summarizes them into a final answer to the original problem. In one or more examples, the workflow execution is not a one-time process. The LLM continually assesses the quality and correctness of the final generated solutions and identifies potential errors. The LLM engages in iterative rerun by applying a different problem decomposition, expert assignments, or adjusting the workflow structure.

According to one or more embodiments, to train the local model to solve complex reasoning problems, a large dataset containing diverse reasoning problems may be used. However, manually creating such a dataset would be time-consuming and labor-intensive. Therefore, to enhance the complex problem-solving capabilities of local LLMs, the embodiments include a novel approach for automatically synthesizing a large-scale dataset of diverse reasoning tasks. To enhance reasoning task diversity and coverage, the data synthesis pipeline may include two stages. In the first stage, human-authored seed tasks may be leveraged to inspire the creation of new reasoning problems or let the LLM brainstorm different genres of puzzles, such as crossword puzzles, math puzzles, number puzzles, relational puzzles, logic puzzles, etc. This stage may only focuses on generating high-level task descriptions. In the second stage, the LLMs may be applied again to write three specific problems based on the description of those reasoning tasks.

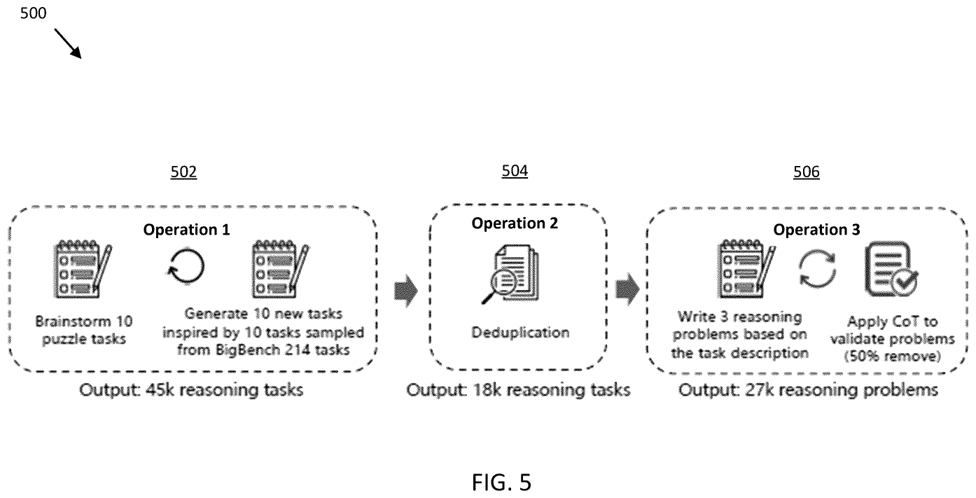

FIG. 5 illustrates an example data synthesis of complex reasoning problems model 500, which may be implemented by the processor 220. The creation and refinement of reasoning problems may contain three operations. Operation 1 (502) involves brainstorming and generating high-level descriptions of new reasoning tasks from human-written tasks or directly writing puzzle tasks. Operation 2 (504) may perform semantic matching and deduplication. The final Operation 3 (506) may apply a CoT validation process to filter or refine the tasks down to 27 k valid reasoning problems.

In one or more examples, Operation 1 (502) task generation inspired by seed tasks. The first operation of the reasoning data synthesis pipeline may include generating an expanded set of tasks inspired by a small collection of seed tasks. The few-shot prompts may be augmented with tasks randomly sampled from the BigBench tasks. Next, the seed tasks may be employed as in-context examples to prompt an LLM to generate, for example, 10 new tasks inspired by seed tasks. By conditioning the LLM on the seed tasks, an expanded pool of 45 k candidate reasoning tasks that cover diverse reasoning types and scenarios may be generated. To encourage additional diversity in the generated tasks, the LLM may generate a plurality (e.g., 10) reasoning puzzles that cover a variety of task formats, difficulty levels, and problem domains. This process may be repeated to produce a number puzzles in total.

In one or more examples, in Operation 2 (504), data filtering and deduplication may be performed. The previous task generation step produces a sizable pool of candidate reasoning tasks. However, the generated data may contain duplicate or highly similar entries since the LLM may propose redundant tasks and questions. To address this, a comprehensive data filtering and deduplication process may be employed. First, an n-gram to identify nearly identical tasks may be employed. Next, any tasks or problems that fail to meet quality criteria, such as insufficient complexity (e.g., trivial one-step questions), ambiguity in the description, or lack of a valid answer, may be filtered out. This helps ensure that only high-quality, unambiguous reasoning problems are retained in the final dataset. Through this rigorous deduplication and filtering process, the pool of generated tasks down to deduplicated tasks, and the synthesized problems down to a refined set of complex reasoning problems. This curated dataset offers both scale and diversity to support the training of LLMs on a wide range of reasoning skills.

In Operation 3 (506), reasoning problem synthesis may be performed. In the second stage, multiple concrete reasoning problems for each of the tasks produced by the previous task generation and deduplication steps may be produced. Taking each task's description as input, an LLM may be prompted to generate 3 distinct questions or problems that test the specified reasoning skill. This enables us to turn each high-level task into a set of actual solvable questions, resulting in an expanded pool of 54 k reasoning problems. To ensure the generated problems are well-posed and solvable, a chain-of-thought (CoT) based validation step may be employed. In one or more examples, an LLM may be employed to apply CoT to each synthesized problem and analyze if the resulting reasoning steps coherently lead to a single answer. Problems for which the model fails to converge to a clear solution or exhibits inconsistent reasoning are filtered out. This validation process helps improve the overall quality of the synthesized reasoning problems.

An example reasoning problem generated by the model 500 may include “Interpret a Morse Code Message”: Given a string of Morse code, translate it into English text, adhering to standard Morse code conventions. The task involves recognizing each sequence of dots (.) and dashes (-) as letters and spaces as separators for words. A Morse code sequence has been found etched into an old artifact. It is believed to be a significant mathematical formula. The Morse code is: ‘-. .. -. . - -.-/- .... .-. . ./- .. - . .../... . ...- . -. - -.-/..-. .. ...-./. -.- ..- .- .-.. .../- -. ./.... ..- -. -.. .-. . -../. - -. -../- .- . -. - -.-/- .... .-. . .’. Decode this Morse code into English text, adhering to the standard Morse code conventions where sequences of dots (.) and dashes (-) represent letters, and spaces are used to separate words.

An example reasoning problem generated by the model 500 may include “Cryptarithm Task: Solve the Equation”: In this cryptarithm, each letter represents a unique digit from 0-9: **CROSS+ROADS=DANGER** No number may begin with zero.

Determine the digit each letter represents to satisfy the equation.

The embodiments were tested on the following reasoning benchmark datasets.

BIG-Bench Hard (BBH): A subset of 27 challenging tasks from the BIG-Bench benchmark, which aims to measure the capabilities and limitations of language models across diverse text-based tasks. The selected tasks are those for which no prior result has outperformed the average human-rater score. MATH: A dataset consisting of 5,000 test problems from mathematics competitions. These problems assess the mathematical problem-solving ability and often require the application of problem-solving techniques and heuristics beyond standard K-12 mathematics tools. Game of 24: A mathematical reasoning challenge dataset containing 1,362 games sorted by human solving time. The goal is to use four given numbers and basic arithmetic operations (+−*/) to obtain 24, with success defined as generating a valid equation that equals 24 and using each input number exactly once. Mathematical Reasoning: A dataset consisting of various types of mathematics questions, released with both generation code and pre-generated questions. This dataset provides an additional measure of algebraic generalization abilities.

The systematic execution of workflow graphs, driven by the integration of LLMs and expert modules, represents a powerful approach to complex problem-solving. By decomposing problems into sub tasks, assigning them to specialized experts, and coordinating their execution through dynamic workflows, our system achieves a level of problem-solving proficiency that surpasses traditional approaches. The combination of the LLM's high-level reasoning, memory management, and natural language processing capabilities, coupled with the specialized knowledge and skills of the expert modules, enables the system to tackle a wide range of complex problems across various domains. This hybrid thinking approach opens up new possibilities for LLMs to assist in scientific discovery, decision-making, and creative problem-solving.

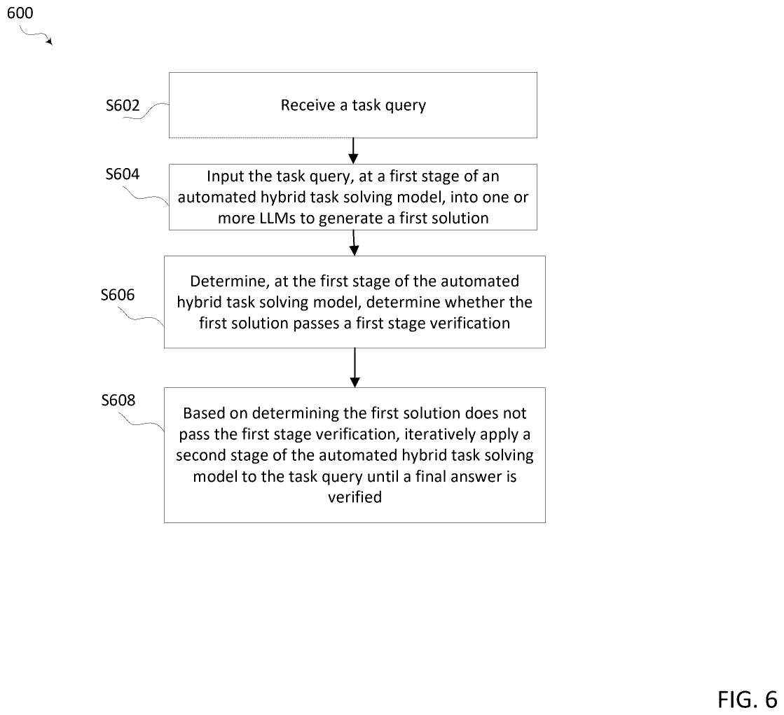

FIG. 6 illustrates a flowchart of a process 600 for generating an answer to a query. The process 600 may be implemented by the processor 220.

The process may start at operation S602, where a task query is received.

The process proceeds to operation S604, where the task query is inputted, at a first stage of an automated hybrid task solving model, into one or more LLMs to generate a first solution. For example, the task query may be input into the fast thinking stage 302 of the automated hybrid task solving model 300 (FIG. 3).

The process proceeds to operation S606 where it is determined whether the first solution passes a first stage verification in the first stage of the automated hybrid task solving model.

The process proceeds to operation S608, where based on determining the first solution does not pass the first stage verification, a second stage of the automated hybrid task solving model is applied to the task query until a final answer is verified. For example, the slow thinking stage 304 may be iteratively applied to the task query.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more. ” Furthermore, as used herein, the term “set” is intended to include one or more items (e.g., related items, unrelated items, a combination of related and unrelated items, etc.), and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving a task query;
inputting the task query, at a first stage of an automated hybrid task solving model, into one or more large language models (LLMs) to generate a first solution;
determining, at the first stage of the automated hybrid task solving model, determining whether the first solution passes a first stage verification; and
based on determining the first solution does not pass the first stage verification, iteratively applying a second stage of the automated hybrid task solving model to the task query until a final answer is verified.

2. The method according to claim 1, wherein the one or more LLMs generate the first solution in accordance with a chain-of-thought reasoning process.

3. The method according to claim 1, wherein in the second stage of the automated hybrid task solving model, the one or more LLMs analyze the task query and generates a plurality of sub-tasks from the task query.

4. The method according to claim 3, wherein the one or more LLMs organize at least two sub-tasks from the plurality of sub-tasks into a logical order such that one or more outputs from a first sub-task are input into a second sub-task.

5. The method according to claim 3, wherein each sub-task from the plurality of sub-tasks comprises a portion that is non-overlapping with other sub-tasks from the plurality of sub-tasks.

6. The method according to claim 3, further comprising:
generating code comprising one or more instructions to execute one or more of the sub-tasks from the plurality of sub-tasks.

7. The method according to claim 3, further comprising:
assigning each sub-task to a LLM from the one or more LLMs configured to perform one or more operations associated with a respective sub-task or to a tool expert configured to perform one or more operations associated with the respective sub-task; and
arranging each sub-task into a workflow sequence.

8. The method according to claim 7, wherein the one or more LLMs generate the final answer using an output from one or more sub-tasks from the plurality of sub-tasks.

9. The method according to claim 1, performing a training process to train the one or more LLMs, the training process comprising:
prompting the one or more LLMs to generate a first number of reasoning tasks from a second number of seed tasks, wherein the first number is larger than the second number; and
filtering the first number of tasks to remove duplicate tasks to generate a third number of reasoning tasks, wherein the third number is less than the first number.

10. The method according to claim 9, wherein the training process further comprises:
prompting the one or more LLMs to generate, from the third number of reasoning tasks, a fourth number of reasoning problems solvable by the one or more LLMs, wherein the fourth number is greater than the third number.

11. An apparatus comprising:
at least one memory configured to store computer program code; and
at least one processor configured to access said at least one memory and operate as instructed by said computer program code, said computer program code including:
receiving code configured to cause the at least one processor to receive a task query;
inputting code configured to cause the at least one processor to input the task query, at a first stage of an automated hybrid task solving model, into one or more large language models (LLMs) to generate a first solution;
determining code configured to cause the at least one processor to, at the first stage of the automated hybrid task solving model, determine whether the first solution passes a first stage verification; and
applying code configured to cause the at least one processor to, based on determining the first solution does not pass the first stage verification, iteratively apply a second stage of the automated hybrid task solving model to the task query until a final answer is verified.

12. The apparatus according to claim 11, wherein the one or more LLMs generate the first solution in accordance with a chain-of-thought reasoning process.

13. The apparatus according to claim 11, wherein in the second stage of the automated hybrid task solving model, the one or more LLMs analyze the task query and generates a plurality of sub-tasks from the task query.

14. The apparatus according to claim 13, wherein the one or more LLMs organize at least two sub-tasks from the plurality of sub-tasks into a logical order such that one or more outputs from a first sub-task are input into a second sub-task.

15. The apparatus according to claim 13, wherein each sub-task from the plurality of sub-tasks comprises a portion that is non-overlapping with other sub-tasks from the plurality of sub-tasks.

16. The apparatus according to claim 13, wherein the program code further includes:
generating code configured to cause the at least one processor to generate code comprising one or more instructions to execute one or more of the sub-tasks from the plurality of sub-tasks.

17. The apparatus according to claim 13, wherein the program code further includes:
assigning code configured to cause the at least one processor to assign each sub-task to a LLM from the one or more LLMs configured to perform one or more operations associated with a respective sub-task or to a tool expert configured to perform one or more operations associated with the respective sub-task; and
arranging code configured to cause the at least one processor to arrange each sub-task into a workflow sequence.

18. The apparatus according to claim 17, wherein the one or more LLMs generate the final answer using an output from one or more sub-tasks from the plurality of sub-tasks.

19. The apparatus according to claim 11, wherein the program code further includes:
performing code configured to cause the at least one processor to perform a training process to train the one or more LLMs, the training process comprising:
prompting the one or more LLMs to generate a first number of reasoning tasks from a second number of seed tasks, wherein the first number is larger than the second number; and
filtering the first number of tasks to remove duplicate tasks to generate a third number of reasoning tasks, wherein the third number is less than the first number.

20. A non-transitory computer readable medium having instructions stored therein, which when executed by a processor cause the processor to execute a method comprising:
receiving a task query;
inputting the task query, at a first stage of an automated hybrid task solving model, into one or more large language models (LLMs) to generate a first solution;
determining, at the first stage of the automated hybrid task solving model, determining whether the first solution passes a first stage verification; and
based on determining the first solution does not pass the first stage verification, iteratively applying a second stage of the automated hybrid task solving model to the task query until a final answer is verified.
